(19) United States
(12) Patent Application Publication
(10) Pub. No.: US 2022/0258893 A1
(43) Pub. Date: Aug. 18, 2022

(54) METHOD AND DEVICE FOR DEPOSITING FRUIT OR VEGETABLES ON CURVED AL VEOLATE TRAYS

(71) Applicant: MAF AGROBOTIC, MONTAUBAN (FR)

(72) Inventor: Stéphane BLANC, MONTAUBAN (FR)

(21) Appl. No.: 17/436,540

(22) PCT Filed: Mar. 5, 2020
(86) PCT No.: PCT/EP2020/055891

§ 371 Date: Apr. 25, 2022

(30) Foreign Application Priority Data
Mar. 6, 2019 (FR) 19.02290

(51) Int. Cl. B65B 35/18; B65B 25/04; B65B 5/10

(52) U.S. Cl. CPC B65B 35/18; B65B 5/105; B65B 25/046

(57) ABSTRACT

The invention relates to a method and a device for placing fruit or vegetables on a tray (11) comprising an upper face (13) having a plurality of recessed cells adapted to be able to receive a single object in each one, two objects placed in two adjacent cells juxtaposed in the same plane being able to come laterally into contact with each other. During any step of placing at least one object in at least one receiving cell (14) adjacent to at least one full cell already containing another object, the upper face (13) of the tray has an upwards envelope curvature adapted to avoid any contact between the objects.

The present invention relates to a method and device for placing objects belonging to the group of fruits and vegetables—in particular umbilicated fruit—on trays, named compartment trays, comprising an upper face having a plurality of recessed cells, juxtaposed in the same horizontal plane, oriented upwards and adapted to be able to receive and support a single object in each one.

Such compartment trays are already known, allowing the packaging of fruit and vegetables, more particularly fruit or vegetables which are generally spherical or globular—in particular umbilicated fruit—such as apples, pears, peaches, quinces, tomatoes, kiwi fruit, melons . . . . These compartment trays can be particularly formed of thin sheets of cardboard or thermoformed thermoplastic polymeric material to provide the cells for receiving the fruit or vegetables. They can also be formed from blocks or plates of thermoplastic polymeric material, the upper face of which is thermoformed to provide the recessed cells in the upper face of the tray. The dimensions of each cell are such that a piece of fruit or a vegetable rests in a cell projecting upwards and laterally away from the cell. In particular, the cells are generally in the form of generally spherical caps, and have a diameter smaller than the largest diameter of the fruit or vegetables to be placed on the tray. In general, each tray receives fruit and vegetables of the same type and same size, but the invention is likewise applicable to different types/sizes. Such compartment trays filled with fruit or vegetables can be particularly placed one above the other in cardboard boxes allowing them to be palletised and/or transported. They can also be placed individually into crates and/or displayed in sales areas.

There are also known methods and devices allowing fruit or vegetables to be manually or automatically oriented on the compartment trays in an at least partially predetermined spatial orientation (in particular common orientation of the umbilical or peduncular axis and/or displaying the most colourful portion at the top), allowing a visually appealing and commercially advantageous display of the products (cf. for example FR2552398, WO2017187076).

The compartment trays are sized (general format, dimensions of each cell, separation distance between the cells, number of cells per tray . . . ) so as to be able to receive predetermined size ranges of fruit or vegetables, with in particular a maximum size for which the objects placed in the adjacent cells are able to come laterally into contact with each other. However, it has proved to be the case in practice that the compartment trays are often used with this maximum size, so as to reduce the relative cost of the trays and optimise the weight of the fruit or vegetables transported by each compartment tray and by each crate. Consequently, it has been found that the cells of a compartment tray are sized and arranged with respect to each other such that two objects placed in two adjacent cells juxtaposed in the same plane (corresponding to the general plane of the compartment tray) are, taking into account the shape and/or size (determined by a maximum diameter or weight) of the objects, able to come laterally into contact with each other. It should be noted in this regard that the fruit or vegetables are objects which do not have a precise and regular shape, but in contrast have shapes and dimensions which can vary from one object to another. This variety of shapes for the objects is likewise the source of risks of lateral contact between the objects. This lateral contact between the objects does not pose a particular problem once the compartment tray is filled with objects. In contrast, such contact may also be advantageous in that the objects are wedged together.

In contrast, the inventor has noted that such contact between the objects whilst they are being placed on the compartment tray has the effect of modifying the orientation of the objects already placed on the tray in the adjacent cells, which would ruin the preferred orientation previously given to these objects already placed on the tray. It should be noted in particular in this regard that when the fruit or vegetables are oriented in an at least partially predetermined orientation, the filling of a compartment tray with fruit or vegetables in an automated filling station is not performed in a single step of placing all of the fruit or vegetables in the different cells of the compartment tray. In fact, the maximum time necessary for the orientation of a piece of fruit or a vegetable by an automatic orienting device cannot be controlled reliably and can be relatively long. It is thus not appropriate to provide a handling robot transferring all of the fruit after they have all been suitably oriented by an orienting device having exactly the same number of fruit or vegetables as that which is to be placed in a compartment tray. In contrast, it is preferable to provide a handling robot removing the fruit or vegetables from an orienting device receiving a higher number of fruit or vegetables than the number of fruit or vegetables which can be transferred and placed by this handling robot. Consequently, the filling of the compartment tray is necessarily effected in several successive placement steps.

Furthermore, such contact between the objects as they are being placed can also have the effect of causing impacts and thus ultimately defects (bruises) in the case of particularly fragile objects. Taking into account the fact that the fruit or vegetables have a shape which is variable, irregular and not perfectly spherical, the risk of such impacts is increased when the fruit or vegetables are not placed in an at least partially predetermined spatial orientation.

The invention thus aims to overcome at least partially these drawbacks and to propose a method and a device for placing fruit or vegetables on a compartment tray, avoiding any contact between the objects as they are being placed on the tray.

It aims more particularly to avoid any inappropriate modification of the orientation of the fruit or vegetables as fruit or vegetables are successively placed on a compartment tray.

It likewise aims to obtain these results in a simple, economic and reliable manner, compatible with its exploitation on an industrial scale in an environment for processing—in particular sorting and packaging—fruit and vegetables.

To this end, the invention relates to a method for placing objects belonging to the group of fruit and vegetables on a tray comprising an upper face having a plurality of cells:
which are recessed,
adapted to be able to receive a single object in each one,
this method comprising a plurality of successive placement steps,
each placement step comprising placing at least one object in at least one free cell, named receiving cell, of the tray,
   characterised in that during any placement step comprising placing at least one object in at least one receiving cell adjacent to at least one cell, named full cell, already containing another object previously placed in this full cell, the upper face of the tray has an upwards envelope curvature adapted to avoid any contact between the object to be placed in this receiving cell and each object present in a full cell adjacent to this receiving cell.

Throughout the text, the expression “envelope curvature” refers to the curvature of a theoretical surface enveloping the upper face of the tray. Generally, the cells are open in the upwards direction and the recesses extend downwards away from the upper face of the tray. Therefore, this envelope curvature corresponds to the general curvature of the upper face of the tray independently of the specific shapes and curvatures which it has in order to form each cell. Furthermore, the expression “upwards curvature” means that the curvature has an upwardly oriented convexity.

Depending upon the placement of each full cell with respect to each receiving cell to which it is adjacent during a placement step, the envelope curvature of the upper face of the tray may be unidirectional (i.e. in a single vertical plane) or multi-directional (i.e. in several different vertical planes) or three-dimensional (i.e. in any vertical plane).

Owing to the invention, when placing an object in a receiving cell of the tray, this object cannot come into contact with adjacent objects previously placed in an adjacent cell during a previous placement step, including in the cases where the cells are sized and arranged with respect to each other such that two objects placed in two adjacent cells juxtaposed in the same plane are, likewise taking into account variations in shape and size of different objects, able to come laterally into contact with each other. In fact, the upwards envelope curvature of the upper face of the tray allows, during placement, a spacing distance to be maintained between the previously placed objects and each object currently being placed, which distance is sufficient, taking into account, on the one hand, the shapes and sizes of the objects and, on the other hand, the existing separating distance between the cells of the tray (resulting from the shape, sizes given to the cells and the distribution thereof when the tray was made) and the curvature given to the portions of the tray separating the adjacent cells resulting from said upwards envelope curvature. Consequently, any risk of modifying the orientation of the objects and any risk of impact between the objects is avoided.

The invention relates to any variants and applications of the method in accordance with the above-mentioned invention. In particular, it relates to placing, on a tray, fruit or vegetables of any kind and any size, which can be of the same or different kind and/or be the same or different size, which can be placed individually one after the other or in groups (for example row-by-row) on the compartment tray, manually or in a fully or partially automated manner, with the cells and/or compartment tray being of any type, kind and size so long as the upper face of the compartment tray has an upwards envelope curvature (i.e. it has an upwardly oriented convexity) fully (i.e. over the entire extent of the upper face of the compartment tray) or at least locally at right angles to each receiving cell during each placement step, regardless of the device(s) used to obtain this upwards envelope curvature of the upper face of the compartment tray, placing the objects on the compartment tray with a spatial orientation which may or may not be at least partially predetermined.

In some embodiments of the invention, a compartment tray is used in which at least the upper face is deformable by bending, elastically or plastically, so as to be able to have said upwards envelope curvature during a placement step, and then flattened after all of the cells of the tray have been filled. This bending deformation of at least the upper face of the compartment tray can be obtained by bending deformation of all of the compartment tray across its entire thickness. However, in contrast there is nothing to prevent provision being made that only an upper part of the thickness of the compartment tray having said upper face is deformable by bending.

In some embodiments, after all of the cells of the tray have been filled, the upper face of the tray is flattened in the sense of decreasing the upwards envelope curvature of the upper face of the compartment tray—in particular until the cells are all juxtaposed in the same plane. However, in contrast there is nothing to prevent provision being made that said upwards envelope curvature of the upper face of the compartment tray is at least partially retained after the compartment tray has been filled, the upper face of the compartment tray still having said upwards envelope curvature or at least some upwards envelope curvature.

In some embodiments of the invention, the upwards envelope curvature imparted to the upper face of the compartment tray can be obtained by shaping the compartment tray, or at least the upper face thereof, to the curved state, when it is being made. In this variant, compartment trays are used which are made with said upwards envelope curvature at least of their upper face, and thus having, at rest (i.e. without any force applied to the tray), this upwards envelope curvature. Therefore, said upwards envelope curvature of the upper face of the tray results from the shape of the tray at rest. In particular, compartment trays can be used which are formed from sheets manufactured so as to have, at rest, said upwards envelope curvature.

Preferably, after all of the cells of such a compartment tray—of which at least the upper face has, at rest, said upwards envelope curvature—have been filled, the upper face of the compartment tray is flattened by deformation (elastic or plastic) at least of this upper face—in particular by plastic bending deformation of the tray—in the sense of decreasing the upwards envelope curvature of the upper face of the compartment tray—in particular until the cells are all juxtaposed in the same plane. This deformation can result from the simple weight of the objects successively placed in the cells of the compartment tray and/or the effect of a deformation device activated after different cells of the compartment tray have been filled, in order to flatten this upper face.

In some embodiments of the invention, said upwards envelope curvature of the upper face of the tray is produced by bending deformation. Therefore, in these embodiments, the upper face of the tray as a whole is initially planar, all of the cells being juxtaposed in the same plane, and this upper face of the tray is deformed by bending so as to have said upwards envelope curvature during any placement step comprising placing an object in a receiving cell adjacent to at least one full cell. This bending deformation of the upper face can be obtained by bending deformation of the tray across its entire thickness or, in contrast, by bending deformation of only part of the thickness of the tray. Furthermore, this bending deformation of the upper face of the tray can be an elastic deformation or a plastic deformation.

According to particular embodiments, in a method in accordance with the invention, a tray is used formed of a sheet which is plastically deformed—in particular thermoformed—across its entire thickness to have said cells on its upper face. It can be a tray selected from cardboard compartment trays and compartment trays made of thermoplastic polymeric materials. Such a compartment tray is generally elastically deformable, by bending, such that the upper face thereof can have said upwards envelope curvature.

In accordance with particular embodiments:
said bending deformation comprises activating at least one deformation device selected from pistons, rollers, inflatable cushions, ramps and air jets;
in a method in accordance with the invention, during any placement step comprising placing an object in at least one receiving cell adjacent to at least one full cell, the upper face of the tray has an upwards envelope curvature at least locally at right angles to each receiving cell in which an object is placed during this placement step; in accordance with a first possible embodiment variant, all of the upper face of the tray has an upwards envelope curvature during all of the successive placement steps; as a variant, during any placement step comprising placing an object in at least one receiving cell adjacent to at least one full cell, the upper face of the tray has an upwards envelope curvature only locally at right angles to each receiving cell in which an object is placed during this placement step;
each placement step comprises placing, by a robot, a single object in a single receiving cell; as a variant, each placement step comprises simultaneously placing, by at least one robot, a plurality of objects in a plurality of corresponding receiving cells; in particular, when a rectangular tray is used comprising a plurality of parallel rows of cells, the objects can be placed row-by-row;
each object is oriented, as it is being placed in a receiving cell, in an at least partially predetermined spatial orientation;
since the objects are of the same kind or same size, said at least partially predetermined spatial orientation is similar for all of the objects; this similar orientation can be in particular the axial orientation of the umbilicus and/or of the peduncle, and/or the orientation of a more colourful part of the objects in the upwards direction, or the like.

The invention relates to a device for implementing a method in accordance with the invention.

It thus likewise relates to a device for placing objects belonging to the group of fruit and vegetables on trays, each tray comprising an upper face having a plurality of cells:
which are recessed,
adapted to be able to receive a single object in each one,
   this device being adapted to be able to perform, on each tray, a plurality of successive steps of placing at least one object on this tray, each placement step comprising placing at least one object in at least one free cell, named receiving cell, of the tray,
   characterised in that it comprises a device able to curve the upper face of the tray according to an upwards envelope curvature adapted to avoid any contact between objects when placing an object in a receiving cell whilst another object is already present in at least one other cell adjacent to this receiving cell.

In accordance with particular embodiments:
the device able to curve the upper face of the tray according to said upwards envelope curvature can be adapted to be able to curve the upper face at least locally at right angles to each receiving cell, i.e. either only locally at right angles to each receiving cell or over all of the receiving face; it can likewise be adapted to deform, by bending, at least the upper face of the tray—in particular all of the compartment tray across the entire thickness thereof when the latter is deformable by bending;
said device able to curve the upper face of the tray comprises at least one deformation device selected from pistons, rollers, inflatable cushions, ramps and air jets;
a device in accordance with the invention comprises at least one robot for handling objects;
each robot is adapted to place each object in a cell of the tray in an at least partially predetermined spatial orientation.

The invention likewise relates to a method performed by a device in accordance with the invention.

The invention likewise relates to a method and a device which are characterised in combination or individually by all or some of the features mentioned above or below. However they are formally presented, unless explicitly stated otherwise, the different features mentioned above or below should not be considered to be closely or inextricably linked with each other, the invention being able to relate to only one of these structural or functional features, or only some of these structural or functional features, or only part of one of these structural or functional features, or even any group, combination or juxtaposition of all or some of these structural or functional features.

### BRIEF DESCRIPTION OF THE DRAWINGS

Other aims, features and advantages of the invention will become apparent upon reading the following description given by way of non-limiting example of some possible embodiments thereof, and which makes reference to the attached figures in which:

FIG. 1 is a perspective diagram showing an example of a compartment tray partially filled with apples,

FIG. 2 is a schematic elevation of an example of a fully automated placing device in accordance with the prior art,

FIG. 3 is an elevation diagram of a placement step of a placing method and placing device in accordance with a first embodiment of the invention,

FIG. 4 is a vertical cross-sectional diagram along line IV in FIG. 3,

FIG. 5 is a diagram from above of a conveyor for supplying trays in accordance with the first embodiment of the invention,

FIG. 6 is a cross-sectional diagram of a detail showing two adjacent cells of a generally planar upper face of a compartment tray,

FIG. 7 is a diagram similar to FIG. 6 showing the cells when the upper face has said upwards envelope curvature,

FIG. 8 is an elevation diagram of a placement step of a placing method and placing device in accordance with a second embodiment of the invention,

FIG. 9 is a vertical cross-sectional diagram along line IX in FIG. 8,

FIG. 10 is an elevation diagram of a placement step of a placing method and placing device in accordance with a third embodiment of the invention,

FIG. 11 is a vertical cross-sectional diagram along line XI in FIG. 10.

### DESCRIPTION OF EMBODIMENT(S)

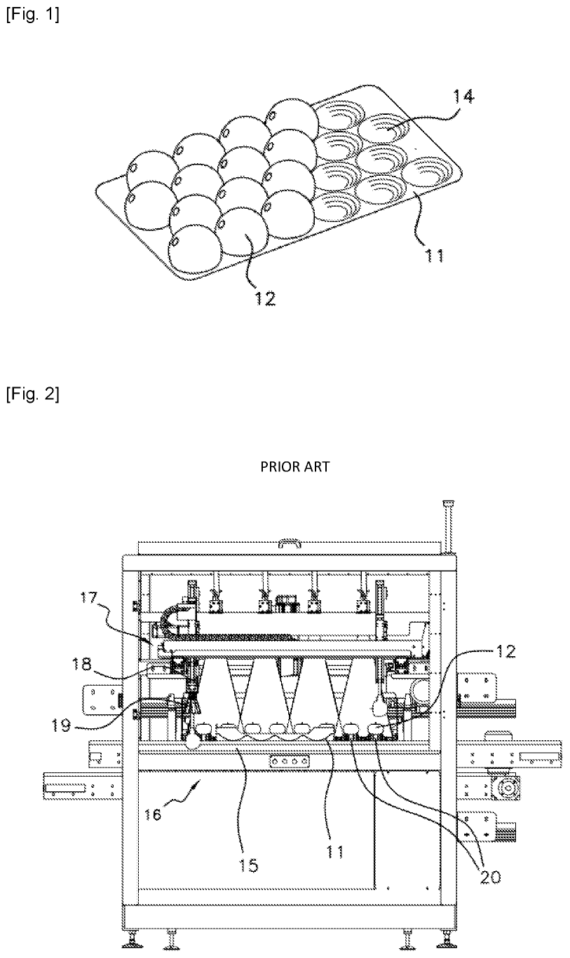

The invention relates to a method and a device for placing objects belonging to the group of fruit or vegetables on compartment trays 11, an example of which is shown in FIG. 1. In other words, it relates to a method and a device for filling compartment trays 11 with fruit or vegetables, or even a method and a device for packaging fruit or vegetables in compartment trays 11.

The invention is applicable to all fruit or vegetables which are able to be thus packaged on compartment trays, more particularly selected from fruit or vegetables sensitive to impacts (e.g. apples, pears, peaches, tomatoes, . . . ) and/or from fruit or vegetables to be placed on the tray in an at least partially predetermined spatial orientation of each piece of fruit or each vegetable, in particular umbilicated fruit or vegetables. It is applicable more particularly but not exclusively to generally spherical or globular fruit or vegetables. In the example shown in the figures, these are apples 12.

Each compartment tray 11 has an upper face 13 which is normally generally planar, i.e. having a normally planar theoretical envelope surface. Each compartment tray 11 is, most often, rectangular and has a plurality of recessed cells 14 in the upper face 13, juxtaposed in the same horizontal plane, oriented upwards (i.e. recessed downwards and with the opening oriented upwards) and adapted to be able to receive and support a single object in each one, i.e. a single piece of fruit or single vegetable, i.e. a single apple 12 in the illustrated example.

The shapes and dimensions of each cell 14 are selected such that a piece of fruit or a vegetable rests in a cell projecting upwards and laterally with respect to the cell 14 (only one part of the fruit or vegetable is housed in the recess of the cell). Most often, the same compartment tray 11 is intended to receive fruit or vegetables of the same kind and of the same size. Consequently, most often all of the cells 14 of the same tray 11 have similar shapes and dimensions. Furthermore, the cells 14 can be arranged in longitudinal rows and/or lateral rows and/or staggered or in any manner on the upper face 13 of the tray. Furthermore, the cells 14 of a compartment tray 11 are sized and arranged with respect to each other such that two fruit or vegetables placed in two adjacent cells 14 juxtaposed in the same plane (corresponding to the general plane of the compartment tray 11) are, likewise taking into account the shape and/or size and/or variations in shape of the fruit or vegetables, able to come laterally into contact with each other.

In a method in accordance with the invention for placing fruit or vegetables on the same compartment tray 11, a plurality of successive placement steps are performed, each placement step comprising placing at least one piece of fruit or vegetable in at least one free cell, named receiving cell 14, of the tray 11. During each placement step, the number of fruit or vegetables placed in the corresponding cells of the tray 11 is lower than the total number of cells of the tray 11. Consequently, the filling of a single compartment tray 11 requires a plurality of successive placement steps.

Each placement step can be performed in a fully manual manner by a human operator removing the fruit or vegetables from a stock of fruit or vegetables or from a device supplying fruit or vegetables and placing them manually successively in the cells of the tray 11. Each placement step can also be preformed in a partially automated manner, i.e. using a handling device controlled by a human operator. Each placement step can also preferably be performed in a fully automated manner, i.e. by at least one robot for filling the trays which removes the fruit, individually or in groups, from a stock of fruit or vegetables or from a device supplying fruit or vegetables to place them, individually or in groups, in each receiving cell 14 of the tray 11.

FIG. 2 shows an example of a fully automated placing device as described in particular in WO 2017187076. This device comprises a conveyor 15 supplying trays 11 successively one behind the other facing at least one station 16 for placing fruit or vegetables in the trays 11. Each placing station 16 comprises at least one robot 17 for filling trays, which is provided with at least one handling arm 18, the lower end of which has a suction cup 19 for gripping a piece of fruit or a vegetable. The station 16 likewise advantageously comprises a device 20 for orienting fruit or vegetables in an at least partially predetermined spatial orientation. An example of such an orienting device 20 is described in detail in WO 2017187076. The filling robot 17 is adapted to be able to remove a piece of fruit or a vegetable 12 from the orienting device 20 after the piece of fruit or vegetable has been at least partially oriented thereby. In particular, this orientation can comprise an orientation of the umbilicus of the fruit in a preferred direction (all the fruit placed on the same tray having the same umbilical orientation) and/or an upward orientation of the most colourful portion of the fruit, or some other orientation.

The filling robot 17 is adapted to then move the handling arm 18 above a receiving cell 14 of a tray 11 and to control the gripping suction cup 19 so as to release the piece of fruit or vegetable in the receiving cell 14. The general features of such a placing device may be subject to any variants. In particular, the device can comprise several successive placing stations, several tray-supplying conveyors, several orienting devices, several tray-filling robots, each robot can comprise several handling arms for simultaneously transporting several pieces of fruit or vegetables, in particular in rows . . . . Other examples of automated placing devices are described in FR 2552398, FR2663903 or WO 2017150968.

Each compartment tray 11 can be formed from a sheet made from cardboard and/or a thin thermoplastic polymeric material thermoformed across its entire thickness to have the cells 14, the tray 11 having a lower face 21 likewise thermoformed and having bosses extending downwards corresponding to the cells 14 of the upper face 13. Such a tray 11 can be deformed by bending, either locally or as a whole (i.e. across the entire extent of its upper face 13), this deformation being elastic, i.e. so as to resume its initial generally planar shape after the imparted deformation force has been removed.

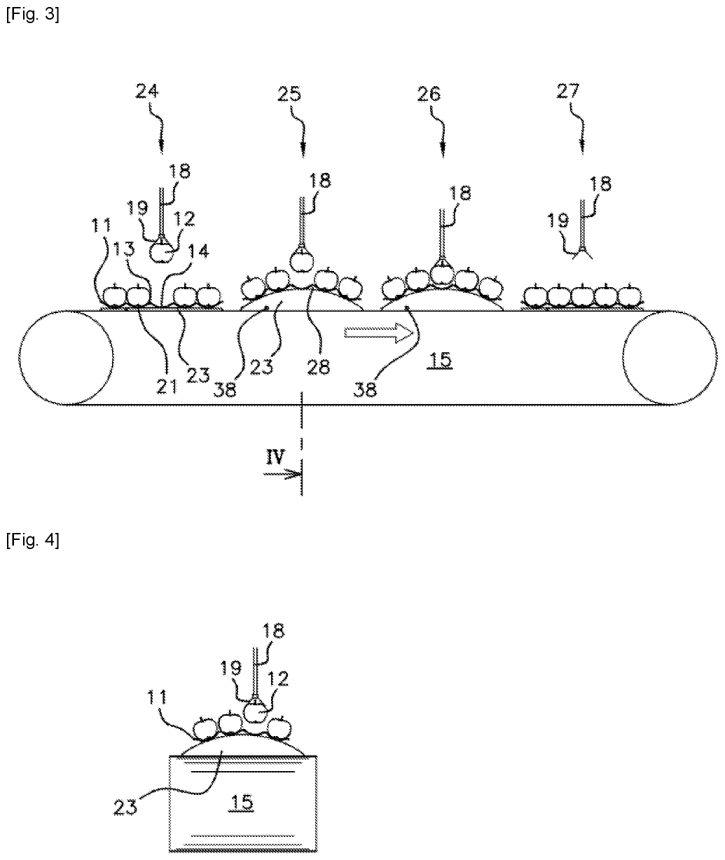

FIG. 3 shows a first embodiment of the conveyor 15 for supplying the trays of a device in accordance with the invention comprising inflatable pockets 23 for receiving the trays 11. FIG. 3 shows four successive phases 24, 25, 26, 27 of a step of placing an apple in a receiving cell 14 of a tray 11.

Each inflatable pocket 23 is fixedly attached to the belt 30 of the conveyor 15 for supplying trays (FIG. 5) and comprises an upper wall 28 adapted to be able to receive, when the inflatable pocket 23 is deflated, a flat tray 11 as shown in the first phase 24. In this first phase 24, the handling arm 18 of the robot 17 carries an apple and is placed vertically above a free receiving cell 14 of the tray 11. The cells of the tray 11 adjacent to this receiving cell 14 are full, i.e. have previously been supplied or filled with an apple during a previous placement step.

In the second phase 25, the inflatable pocket 23 is inflated with compressed air supplied from a compressed air source 33 (FIG. 5) which can be formed by a simple air compressor. To this end, a rail 44 fixed relative to the frame of the tray-supplying conveyor 15 extends on one side of, and in parallel with, the belt 30. A cylinder 35 slides in this rail 44, the actuating rod of which has, at its end, an air injection nozzle 36 connected by a flexible line 37 to the compressed air source 33 (left-hand part of FIG. 5). The length of the line 37 is adapted to allow the translational movement of the cylinder 35 in the rail 44 over a predetermined course. The cylinder 35 is slidingly driven in the rail 44 by a drive device (not shown) so as to follow the movement of the belt 30. The inflatable pocket 23 has a lateral inflation valve 38 oriented laterally towards the rail 44 having the air injection nozzle 36. During the second phase 25, the air injection nozzle 36 is moved by sliding of the cylinder 35 in the rail 44 so that it faces the valve 38 of the pocket, the cylinder 35 is then actuated so as to extend its actuating rod transversely to the sliding axis of the cylinder, the injection nozzle 36 penetrating into the inflation valve 38, this latter then being opened so as to cause inflation of the pocket 23.

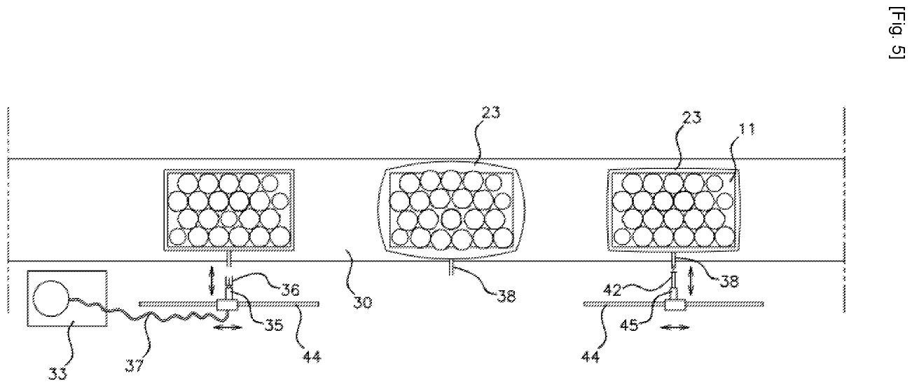

The inflatable pocket 23 is such that when it is inflated with compressed air its upper wall 28 has a shape curved with an upwardly oriented convexity (FIG. 3) this being the case both in any longitudinal vertical plane in parallel with the advancing direction of the tray-supplying conveyor 15 and in any transverse vertical plane perpendicular to the advancing direction of the tray-supplying conveyor 15 (FIG. 4). The upper wall 28 is thus in the general shape of a cap with an upwardly oriented convexity at any point, which can be a spherical cap or a spheroid cap, or a convex paraboloid cap, or even a cap of no particular geometry.

The compartment tray 11 which rests on the upper wall 28 deforms, by bending, to follow the curvature of this domed upper wall 28. This deformation can result from the fact that the peripheral cells of the tray have been filled with apples first, the weight of these apples at the periphery of the tray 11 causing the bending deformation of the latter when the inflatable pocket 23 is inflated. As a variant, not shown, or in combination, it is likewise possible for provision to be made that the four corners and/or the peripheral edges of the tray 11 are fixed to the upper wall 28 of the inflatable pocket 23, for example by insertion into peripheral notches and/or rims of this upper wall 28. Owing to the bending deformation of the tray 11, the upper face 13 of the tray has a general curvature with an upwardly oriented convexity, i.e. an upwards envelope curvature (phases 25 and 26 in FIGS. 3 and 4).

The curvature in the longitudinal direction and in the transverse direction of the upper wall 28 of the inflatable pocket 23 in the inflated state is selected, taking into account the shape and dimensions of the cells 14 and the shape, variations in shape, and size of the apples to be placed on the tray 11, so that said upwardly oriented envelope of the upper face 13 of the tray allows any contact between the apple to be placed in the receiving cell 14 and the apples already placed in the adjacent cells of the tray to be avoided.

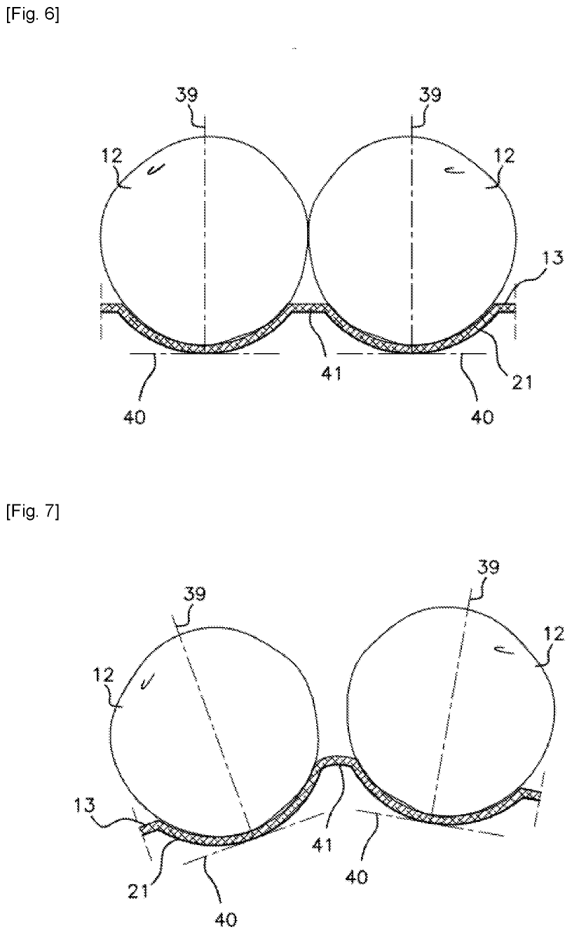

FIGS. 6 and 7 show the relative positions of apples and adjacent cells with and without said upwards envelope curvature. In the situation in FIG. 6, the upper face 13 of the tray 11 is assumed to be generally planar, i.e. the theoretical envelope surface to this upper face 13 of the tray is a horizontal plane. For each cell 14, a straight line 39 can be defined, representing the spatial orientation of this cell 14. This line 39 is, for example, as shown in FIG. 6, the normal to a plane 40 tangential to the deepest point of the cell 14. This line 39 can likewise be defined as being the normal to the cross-section of the opening of the cell; in FIG. 6, the cross-section of the opening of the cell is substantially in the plane of the upper face 13 of the tray. In the situation in FIG. 6, the different orientation lines 39 of the different cells 14 are in parallel with each other and vertical, and the deepest points of the cells 14 are located in the same horizontal plane 40. The two adjacent cells 14 are connected to each other by a portion 41 of the tray 11 which, in the example, is substantially planar and horizontal.

FIG. 7 shows the two cells 14 of FIG. 6, after bending deformation of the tray 11 to form said upwards envelope curvature of its upper face 13. As can be seen, the orientation lines 39 of the two adjacent cells 14 are no longer parallel, the planes 40 tangential to the deepest points of the cells are not coincident, and the linking portions 41 between the adjacent cells 14 have a more pronounced curvature with an upwardly oriented convexity. The result is an increase in the spacing between the orientation lines 39 of the cells at the level corresponding to the maximum horizontal diameter of the apples, at a distance sufficient to avoid any contact between the apples contained in the two adjacent cells, and in particular to avoid any contact between these applies when placing one of them in its corresponding cell whilst the other apple is already present in its corresponding cell.

Therefore, during the third phase 26 shown in FIG. 3, when the handling arm 18 of the robot 17 is moved vertically downwards, the apple which it carries is inserted between the apples of the cells adjacent to the receiving cell 14, without any lateral contact between these apples.

The suction cup 19 of the robot 17 can then be controlled to release the apple in the receiving cell 14, and then the inflatable pocket 23 can be deflated during the fourth phase 27 shown in FIG. 3. The upper wall 28 of the inflatable pocket 23, as well as the tray 11, thus resume a generally planar shape. As this is taking place, lateral contact can occur between the apples present in the adjacent cells of the tray 11, but this lateral contact does not change the orientation of the apples and does not cause impacts able to damage them.

Deflation of the inflatable pocket 23 can be performed by a deflation needle 42 carried at the end of the actuating rod of a deflation cylinder 45, itself guided and driven in sliding translation in a rail 44 (right-hand part of FIG. 5). For the deflation of the inflatable pocket 23, the deflation cylinder 45 is moved in the rail 44 such that the needle 42 comes to face the valve 38 of the pocket 23. The cylinder 45 is then actuated such that the needle 42 penetrates into the valve 38, causing deflation of the pocket 23.

In a variant, not shown, of this first embodiment of the invention, the inflatable pockets are not fixedly attached to the supplying conveyor 15 but are incorporated in the thickness of the trays 11, beneath the upper face 13 thereof.

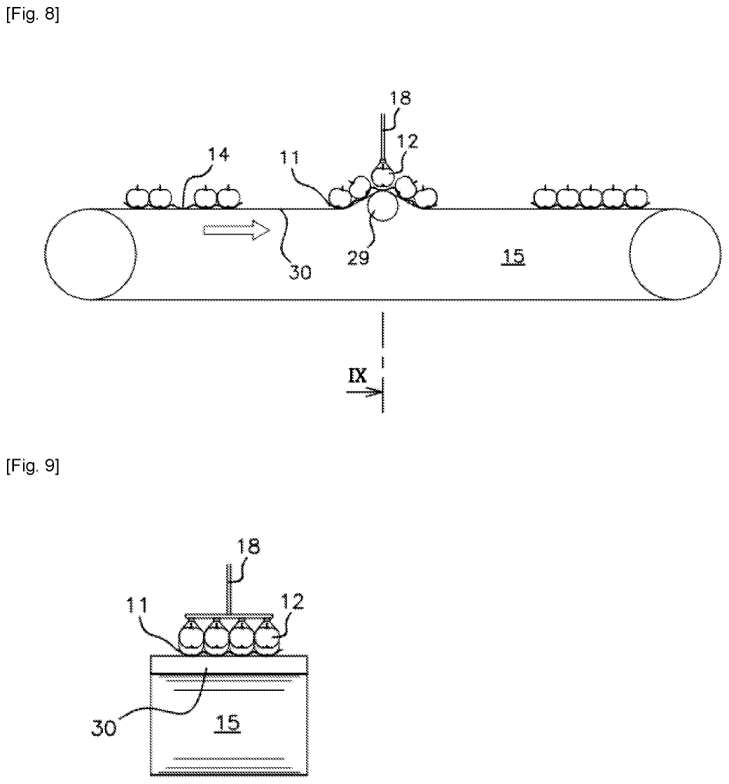

The second embodiment of the invention shown in FIGS. 8 and 9 differs from the previous embodiment in that the device able to curve the upper face 13 of the tray 11 as a whole is formed not by inflatable pockets but by at least one roller 29 applied beneath the flexible belt 30 of the tray-supplying conveyor 15 so as to deform, by bending, and to curve this flexible belt 30 and the tray 11 carried thereby locally upwards such that the upper face 13 of the tray 11 locally has a cylindrical upwards envelope curvature corresponding to the cylindrical shape of the cylindrical roller 29. Again, the curvature of the tray 11 can result only from the bending thereof under the effect of the weight of the apples previously placed in the peripheral cells and/or owing to the fact that the corners of the tray and/or at least one part of its peripheral edges are rigidly fixed to the belt 30, for example by means of notches, clips or any other fixing means.

The curvature thereby imparted to the belt 30 and to the tray 11 corresponds to the shape of the roller 29 and is thus—if the roller 29 is itself cylindrical—a cylindrical curvature produced around the axis of the cylinder which itself is perpendicular (transverse) to the longitudinal driving direction of the belt 30 of the supplying conveyor 15. Therefore, the tray 11 is not curved around a longitudinal axis. All of the cells of a single transverse row of the tray 11 passing above the cylindrical roller 29 remain horizontally aligned, but their orientation lines 39 are spaced apart from those of the cells of the adjacent transverse rows under the effect of the cylindrical curving deformation of the compartment tray 11. More particularly, as shown in FIG. 8, the orientation lines 39 of the cells to be filled of a single transverse row of the tray 11 passing above the cylindrical roller 29 remain substantially vertical whilst the orientation lines 39 of the cells of the adjacent transverse rows (before and after the row of the cells to be filled in FIG. 8) are moved away from the vertical under the effect of the deformation of the compartment tray 11. As a variant, not shown, there is nothing to prevent the provision of an ovoid roller 29 thus having a curvature in both directions, longitudinal and transverse, or even a roller of another shape.

Furthermore, the robot 17 thus has a plurality of handling arms 18 and suction cups 19 so as to simultaneously grip and transport a plurality of apples corresponding to the same transverse row of cells of the tray 11 and to place this plurality of apples simultaneously in this transverse row of receiving cells of the tray. Such a handling robot comprising a plurality of handling arms 18 is described for example in FR2663903. Several variants can be envisaged for this second embodiment.

In a first variant, the belt 30 of the supplying conveyor 15 is driven in a continuous movement and the cylindrical roller 29 is free to rotate about a horizontal axis which is fixed relative to the frame of the supplying conveyor 15. In this first variant, the robot 17 is synchronised with the advancement of the belt 30 such that a row of applies is placed in a transverse row of receiving cells 14 at the moment when this row of receiving cells 14 is located precisely above the cylindrical roller 29, vertically in line with the rotational axis of the cylindrical roller 29, the tray 11 being curved as a whole but locally upwards in the portion thereof forming at least this transverse row of receiving cells 14 and the two adjacent transverse rows. The orientation lines of these two adjacent transverse rows are spaced apart by a sufficient distance from the orientation lines of the receiving cells to allow apples to be placed in the transverse row of receiving cells without contact with the apples present in the adjacent transverse rows of cells.

In a second variant, not shown, the tray 11 is filled whilst the supplying conveyor 15 is held fixed facing the placing station 16 and a plurality of cylindrical rollers are placed beneath the flexible belt 30 of the supplying conveyor 15, one cylindrical roller being provided beneath each transverse row of cells of a tray 11 being filled, with the exception of the transverse rows of cells at the longitudinal ends of the tray 11. The cylindrical rollers are mounted so as to rotate freely on horizontal rotational axles which can be individually moved vertically with respect to the frame of the supplying conveyor 15 between a bottom position in which the corresponding cylindrical roller does not interact with the belt 30, and a top position in which the cylindrical roller is applied beneath the belt 30 so as to deform it by curving it upwards, which has the effect of curving the tray 11 upwards locally in its portion forming at least the transverse row of receiving cells 14 which is located above the cylindrical roller and the two adjacent transverse rows. The upwards envelope curvature thereby imparted locally to the upper face 13 of the tray 11 in its portion forming at least this row of receiving cells 14 and the adjacent rows of cells is such that the orientation lines 39 of the adjacent rows of full cells are spaced apart by a sufficient distance to allow apples to be placed in the row of receiving cells 14 without contact with the apples present in the adjacent rows of full cells. The filling robot 17 can thus place the apples in rows in the transverse rows of receiving cells of the tray, one after the other, the cylindrical roller located beneath the row of receiving cells of the tray being actuated into the top position at the time when apples are being placed in this row.

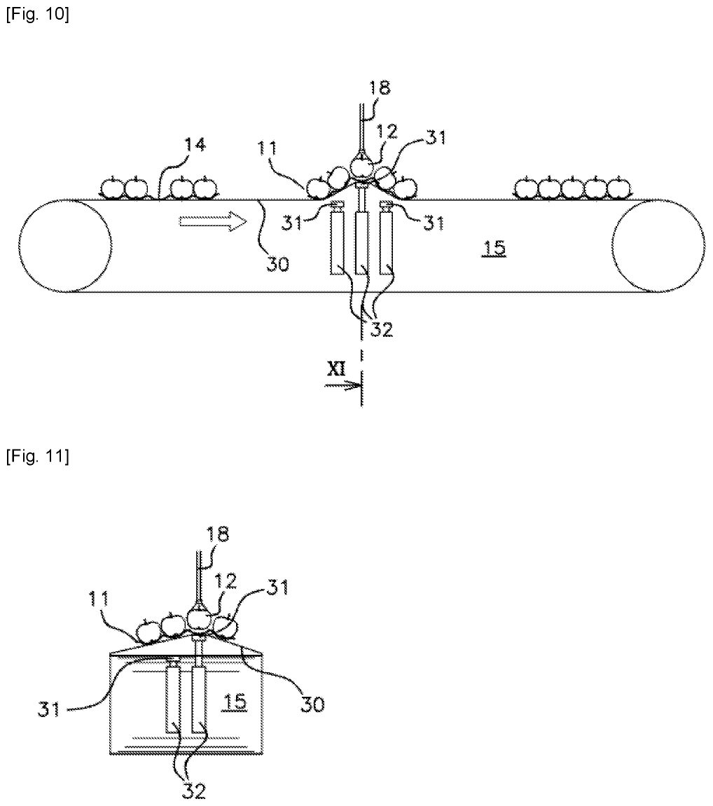

The third embodiment shown in FIGS. 10 and 11 differs from the previous embodiment in that the device able to curve the upper face 13 of the tray 11 is formed from an array of pistons 31 actuated vertically individually by vertical cylinders 32, one piston 31 being provided beneath each cell of the tray 11 in the filling position of the placing station 16, with the exception of the peripheral cells of the tray 11. Each piston 31 can thus be moved individually by actuating its cylinder 32 between a bottom position in which it does not interact with the flexible belt 30 and a top position in which it is applied locally beneath the flexible belt 30 so as to deform it and curve it upwards, as well as the tray 11 locally in its portion forming at least the receiving cell 14 located immediately above the piston 31 and the adjacent cells around this receiving cell 14, and to produce an upwards envelope curvature of the upper face 13 of the tray 11 locally at right angles to these different cells. The filling robot 17 thus comprises a single handling arm 18 allowing an apple to be placed in a receiving cell 14 of the tray 11. However, there is nothing to prevent provision being made that several handling arms 18 which move independently from each other be used to fill the same tray 11 in the placing station 16. The actuation of the pistons 31 is synchronised with that of each handling arm 18 such that the tray 11 is curved upwards in its portion forming at least the receiving cell 14 in which the handling arm 18 must place an apple. The upwards envelope curvature thereby imparted locally to the upper face 13 of the tray 11 is again selected to space apart the orientation line 39 of the receiving cell 14 from the orientation lines 39 of the adjacent cells (or to space apart the orientation lines 39 of the adjacent cells from the orientation line 39 of the receiving cell 14) by a distance sufficient to avoid any contact between the apple to be placed in this receiving cell 14 and the apples already present in the adjacent cells.

In accordance with other embodiments, not shown, the placing device in accordance with the invention is similar to that of the above-mentioned second embodiment but the cylindrical roller forming the device able to curve the upper face 13 of the tray 11 is replaced by at least one longitudinal ramp extending beneath the flexible belt of the conveyor and having an upstream face inclined upwards allowing the flexible belt of the conveyor to be raised, a horizontal or curved face with an upwardly oriented convexity, and a downstream face inclined downwards allowing the belt to be returned to its initial level upstream of the ramp. The belt of the conveyor thus slides over the ramps by being deformed, the compartment trays 11 transported by the conveyor likewise being deformed in the same manner. A single ramp can be provided, the shape of which corresponds to the envelope curvature to be imparted to the upper face of the tray, or a plurality of longitudinal ramps can be provided which are in parallel with each other and adjoin one another laterally to cover the entire width of each compartment tray.

The invention can cover numerous variants and applications other than those described above. In particular, it goes without saying that, unless stated otherwise, the different structural and functional features of each of the embodiments described above should not be considered as being combined and/or closely and/or inextricably linked with each other, but in contrast considered as simple juxtapositions. Furthermore, the structural and/or functional features of the different embodiments described above can form, in their entirety or in part, any different juxtaposition or any different combination.

For example, pistons can be used to curve groups (transverse rows, longitudinal rows or the like) of receiving cells, synchronising the movement of several pistons and/or using pistons each having a shape and dimensions adapted to deform, by bending, a portion of the tray corresponding to several receiving cells (for example each piston being formed by a transverse bar). There is likewise nothing to prevent the use of plastically deformable trays, or even trays of which the upper face has, at rest, an upwards envelope curvature originating from manufacture and able to be elastically or plastically deformed to be returned to being substantially flat after placing fruit and vegetables in the different receiving cells of the trays.

1. A method for placing objects belonging to the group of fruit and vegetables on a tray comprising the tray having an upper face having a plurality of cells:
which are recessed,
adapted to be able to receive a single object in each one,
said method comprising:
a plurality of successive placement steps,
each placement step comprising placing at least one object in at least one free cell, named receiving cell, of the tray,
wherein during any placement step comprising placing at least one object in at least one receiving cell adjacent to at least one cell, named full cell, already containing another object previously placed in this full cell, the upper face of the tray has an upwards envelope curvature adapted to avoid any contact between the object to be placed in this receiving cell and each object present in a full cell adjacent to this receiving cell.

2. The method according to claim 1, wherein, after all of the cells of the tray have been filled, the upper face of the tray is flattened in the sense of decreasing the upwards envelope curvature of the upper face of the compartment tray.

3. The method according to claim 1, wherein said upwards envelope curvature of the upper face of the tray results from the shape of the tray at rest.

4. The method according to claim 1, wherein said upwards envelope curvature of the upper face of the tray is produced by bending deformation.

5. The method according to claim 4, wherein said bending deformation comprises activating at least one deformation device selected from pistons, rollers, inflatable cushions, ramps and air jets.

6. The method according to claim 1, wherein the entire upper face of the tray has an upwards envelope curvature during all of the successive placement steps.

7. The method according of claim 1, wherein during any placement step comprising placing an object in at least one receiving cell adjacent to at least one full cell, the upper face of the tray has an upwards envelope curvature only locally at right angles to each receiving cell in which an object is placed during this placement step.

8. The method according to claim 1, wherein each placement step comprises placing, by a robot, a single object in a single receiving cell.

9. The method according to claim 1, wherein each placement step comprises simultaneously placing, by at least one robot, a plurality of objects in a plurality of corresponding receiving cells.

10. The method according to claim 1, wherein each object is oriented, as it is being placed in a receiving cell, in an at least partially predetermined spatial orientation.

11. The method according to claim 10, wherein since the objects are of the same kind or same size, said at least partially predetermined spatial orientation is similar for all of the objects.

12. A device for placing objects belonging to the group of fruit and vegetables on trays, each tray having an upper face having a plurality of cells:
which are recessed,
adapted to be able to receive a single object in each one,
this device being adapted to be able to perform, on each tray, a plurality of successive steps of placing at least one object on this tray, each placement step comprising placing at least one object in at least one free cell, named receiving cell, of the tray,
wherein said device further comprises a device able to curve the upper face of the tray according to an upwards envelope curvature adapted to avoid any contact between objects when placing an object in a receiving cell whilst another object is already present in at least one other cell adjacent to this receiving cell.

13. The device according to claim 12, wherein said device able to curve the upper face of the tray comprises at least one deformation device selected from pistons, rollers, inflatable cushions, ramps and air jets.

14. The device according to claim 12, wherein said device further comprises at least one robot for handling objects.

15. The device according to claim 14, wherein each robot is adapted to place each object in a cell of the tray in an at least partially predetermined spatial orientation.
